(19) United States
(12) Patent Application Publication
(10) Pub. No.: US 2013/0255969 A1
(43) Pub. Date: Oct. 3, 2013

(54) WEIGHT CONTROLLED SLIP INTERLOCK SYSTEMS AND METHODS

(71) Applicants: Bernt Olsen, Houma, LA (US); Randall D. Legendyk, Houma, LA (US)

(72) Inventors: Bernt Olsen, Houma, LA (US); Randall D. Legendyk, Houma, LA (US)

(73) Assignee: Cudd Pressure Control, Inc., The Woodlands, TX (US)

(21) Appl. No.: 13/431,236

(22) Filed: Mar. 27, 2012

(51) Int. Cl. E21B 19/10; E21B 47/00; E21B 23/00; F16K 31/02

(52) U.S. Cl. 166/382; 166/88.2; 166/65.1; 166/66

(57) ABSTRACT

A weight controlled slip interlock system provides increased safety for a snubbing unit. Slips for a snubbing unit is operable between an open position and a closed position, and valves actuates the slips between the open and closed positions. Weight sensors are coupled to the slips, wherein the weight sensors measures the loads on the slips to determine whether one or more of the slips are controlling the weight of a workstring. Interlocks are coupled to the valves to prevent the valves from actuating from the closed position into the open position when the corresponding slip controls the weight of the workstring.

### FIELD OF THE INVENTION

This invention relates to a slip for a snubbing jack or unit. More particularly, to a weight controlled slip interlock systems and methods.

### BACKGROUND OF INVENTION

Snubbing is the action of running pipes or tubulars into a well or retrieving pipes or tubulars from a well. Snubbing may be performed using a snubbing jack or unit. A snubbing jack imparts vertical force on pipes or tubulars to run or retrieve from the well. As the wellbore may be under pressure, the snubbing jack may be capable of imparting sufficient vertical force to overcome wellbore pressure.

Snubbing jacks may provide multiple slip, such as a stationary and traveling set of slips for pipe heavy conditions and a stationary and traveling set for pipe light conditions. Slips provide an assembly for gripping a tubular or pipe. In an open position, a slip is disengaged from a pipe or tubular to allow a workstring to move freely relative to the slip. In a closed position, the slip engages a pipe or tubular and supports the weight of a workstring or prevents ejection of the workstring (e.g. due to wellbore pressures). A stationary slip maintains the workstring in a stationary position when in a closed position. A traveling or movable slip may travel vertically in a closed position to run or retrieve a workstring.

When a slip is controlling the weight of a workstring, it is undesirable open or disengage the slip because the workstring will be dropped into the well or ejected due to wellbore pressure. For example, if an operator inadvertently opens the one or more slips controlling the weight of a workstring, the workstring will either be ejected from the well or dropped into the well. Additionally, there is the potential for damage resulting from flying objects and the uncontrolled release of well fluids.

Weight controlled slip interlock systems and methods discussed herein monitor the load on the slips in the snubbing unit, and locks the one or more slip(s) when they control the weight of a workstring. Systems and methods discussed herein prevent slips from being actuated to an open position when the slips are controlling the weight of a workstring.

### SUMMARY OF THE INVENTION

In one implementation, a slip for a snubbing unit is operable between an open position and a closed position, and a valve actuates the slip between the open and closed positions. A weight sensor is coupled to the slip, wherein the weight sensor measures a load on the slip to determine whether the slip controls the weight of a workstring; and an interlock is coupled to the valve, wherein the interlock prevents the valve from actuating from the closed position into the open position when the slip controls the weight of the workstring.

In another implementation, a snubbing unit for snubbing provides a first stationary slip for pipe heavy conditions, and a second stationary slip for pipe light conditions. A valve bank is coupled to the first and second stationary slips, wherein a first valve provided by the valve bank actuates the slips between the open and closed positions. A weight sensor is coupled to each of the first and the second stationary slips, wherein a first weight sensor measures a load on the first stationary slip, and a second weight sensor measures a load on the second stationary slip. Interlocks are coupled to the valves, and the interlocks prevents the valves from actuating from the closed position to the open position when the corresponding slip controls the weight of the workstring.

In yet another implementation, a method for controlling a slip interlock system includes the steps of coupling a weight sensor to a slip of a snubbing unit, wherein the weight sensor measures a load on the slip; and coupling an interlock to a valve controlling actuation of the slip between an open position and a closed position, wherein the interlock prevents the valve from opening when the interlock is actuated to a first position. The method also includes determining whether the slip controls the weight of a workstring in accordance with the measured load; and actuating an interlock to the first position when the load measured indicates that the slip controls the weight of the workstring.

The foregoing has outlined rather broadly various features of the present disclosure in order that the detailed description that follows may be better understood. Additional features and advantages of the disclosure will be described hereinafter.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 is an illustrative implementation of a slip interlock system;

FIG. 2 is an illustrative implementation of a valve bank;

FIG. 3 is an illustrative implementation of a stationary heavy slip with a weight sensor;

FIG. 4 is a close up view of an illustrative implementation of a weight sensor;

FIG. 5 is an illustrative implementation of a stationary snub slip with a weight sensor;

FIG. 6 is a close up view of an illustrative implementation of a weight sensor;

FIG. 7 is an illustrative implementation of a user interface for a slip interlock system;

FIG. 8 is an illustrative bar graph of various modes provided by the slip interlock system;

FIG. 9a is an illustrative implementation of a secondary interface; and

FIG. 9b is an illustrative implementation of a secondary interface with a popup window.

### DETAILED DESCRIPTION

Refer now to the drawings wherein depicted elements are not necessarily shown to scale and wherein like or similar elements are designated by the same reference numeral through the several views.

Referring to the drawings in general, it will be understood that the illustrations are for the purpose of describing particular implementations of the disclosure and are not intended to be limiting thereto. While most of the terms used herein will be recognizable to those of ordinary skill in the art, it should be understood that when not explicitly defined, terms should be interpreted as adopting a meaning presently accepted by those of ordinary skill in the art.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

In a snubbing unit or jack, it is desirable to prevent inadvertent disengagement or opening of a slip holding or controlling the weight of a workstring. When a slip is holding or controlling the weight of the workstring, opening the slip disengages slips from the workstring, thereby allowing the workstring to be unsupported by the snubbing unit. As a result, the workstring may fall into the well or may be ejected from the well due to wellbore pressures. Damage can be cause to the workstring, well, and/or surrounding equipment when the workstring falls into the well or is ejected from the well. Further, an uncontrolled release of fluids from the well can also occur.

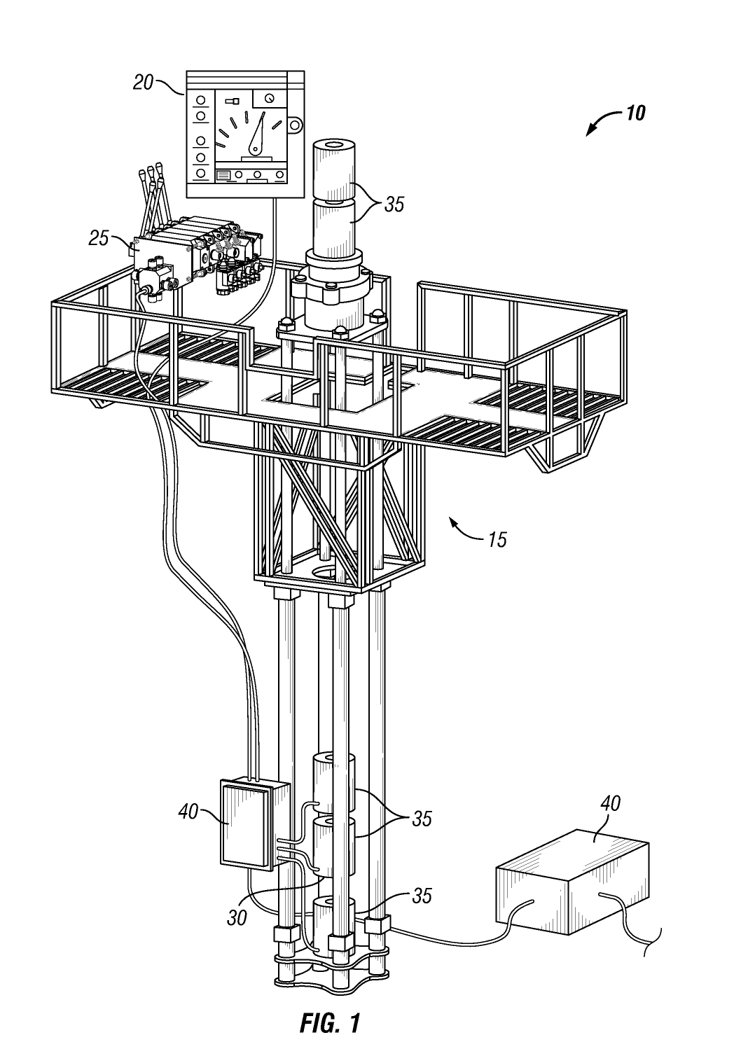

Weight controlled slip interlock systems or methods provide a system utilized to mechanically lock slip controls in a closed or engaged position when the weight sensor system detects that the slip is holding or controlling weight of a workstring. FIG. 1 is an illustrative implementation of a slip interlock system 10. Slip interlock system includes a snubbing unit 15, user interface 20, valve bank 25, weight sensors 30, and controller 40. Snubbing unit 15 is utilized to run or retrieve pipes, tubulars, workstrings, coiled tubing, and the like. Snubbing unit 15 provides multiple slips 35 utilized to engage and disengage pipes, tubing, and the like. User interface 20 may display various information provided by slip interlock system for an operator. Additionally, user interface 20 may provide one or more inputs for controlling slip interlock system 10. Valve bank 25 provides multiple valves that are utilized to control snubbing unit 15. For example, the valves may be utilized to control slip(s) 35 of snubbing unit 15. Weight sensors 30 may be provided on one or more slips 35 of snubbing unit 15 to detect whether a load is present on the slip. A controller 40 may transmit and/or receive signals, data, and other information to or from components of slip interlock system 10. Controller 40 may be coupled to various components of slip interlock system 10 including, but not limited to user interface 20, valve bank 25, and weight sensors 30. In some implementations, controller 40 may be coupled to components via one or more junction boxes 45. The junction box may provide terminals for cabling; may collect and digitize data; may send and receive data; and may provide power to components of slip interlock system 10 via a power supply. Controller 40 may comprise a programmable logic controller (PLC), microcontroller, processor, or a combination thereof.

Valve Bank for Slip Operation

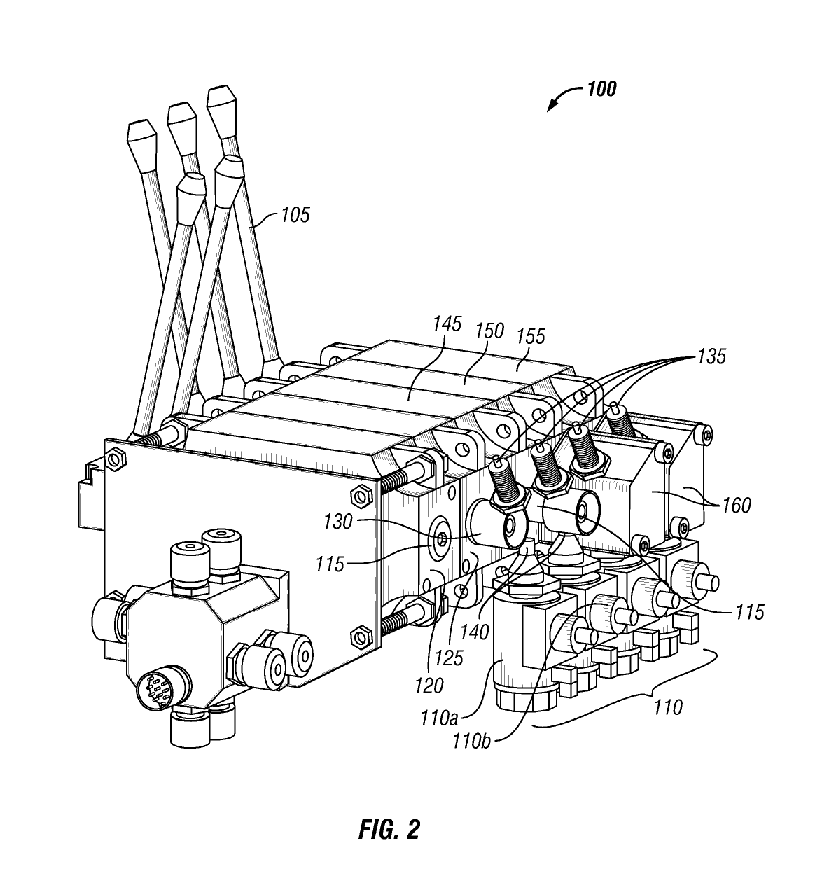

FIG. 2 is an illustrative implementation of a valve bank 100. Valve bank 100 may provide multiple individual valves and multiple levers 105 or the like to control the individual valves. Valve bank 100 may be coupled to a snubbing unit to allow the slips to be opened and closed using levers 105. A interlock 110 may be provided for each of the valves in the valve bank. Interlocks 110 are mounted to the valve bank in a desired position near valve spool 115 of a valve controlling the slips. Interlocks 100 are provided for the purpose of preventing the slips of a snubbing unit from being opened when it is carrying the weight of a workstring. For example, interlocks 110 may be solenoids that can be engaged to block the travel of valve spool 115 or disengaged to unblock the travel of valve spool 115. However, interlocks 110 are not specifically limited to solenoids and may be any suitable electro-mechanical actuator.

For purposes of illustration, first valve 120 of valve bank 100 valve is shown without an interlock 110. First valve 120 is shown in a closed position wherein valve spool 115 is retracted. Second valve 125 has spool extension 130 fitted to the end of a valve spool 115. Additionally, second valve 125 has an interlock 110 and proximity sensor 135. Interlock 110a is shown in an energized state in which stem 140 protrudes to block spool extension 130. Third valve 145 is shown in an open position, in which valve spool 115 extends out of valve bank 100. Valve spool 115 of third valve 145 is fitted with spool extension 130. Interlock 110b is shown in a de-energized state in which stem 140 is not extended from the solenoid. When stem 140 is retracted, valve spool 115 and spool extension 130 may extend freely to allow third valve 145 to be opened and closed. Fourth and fifth valve 150, 155 are shown with end caps 160.

Because interlocks 110 are solenoids, stems 140 retract when de-energized or, in other words, interlocks 110 will deactivate automatically in the event of a power failure. This allows the valve bank 100 to remain operable in the event of a power failure. Further, if interlocks 110 should energize unintentionally due to a fault or the like, spool extension 130 is designed such that a valve can still be closed. It is mechanically impossible to lock lever 105 in an open position so even when interlock 110 is unintentionally energized a valve may still be closed. However, note that once the valve is closed, it may not be opened again until interlock 110 is de-energized.

Proximity sensors 135 detect the position valve spool 115 and spool extension 130 to determine whether the valve is open or closed. Data from proximity sensors 135 may be used to issue alarms. For example, when as user attempts to move lever 105 to an open position when lever 105 is locked in a closed position. Proximity sensors 135 may be fitted with an indicator, such as a small Light Emitting Diode (LED), speaker, a combination thereof or the like. The indicator may be utilized to provide a audio or visual indication of whether the valve is opened or closed. Further, the indicator may audio or visual alarm.

Weight Sensors

During well workover and intervention one may encounter pipe heavy and pipe light conditions. Pipe heavy is when the pipe or workstring weight is greater than the well head pressure and buoyancy forces. As such, in pipe heavy conditions, the weight of the workstring exerts a downward load into the well, and the workstring can fall into the well if slip(s) from a snubbing unit do not secure the workstring. Pipe light is when the pipe or tubing string weight is less than the wellhead pressure and buoyancy forces. During pipe light conditions, the wellhead pressure and buoyancy forces are greater than the weight of the workstring, and the workstring can be ejected from the well if not secured by the slip(s) of a snubbing. A snubbing unit may provide slips for both pipe light conditions and slips for pipe heavy conditions.

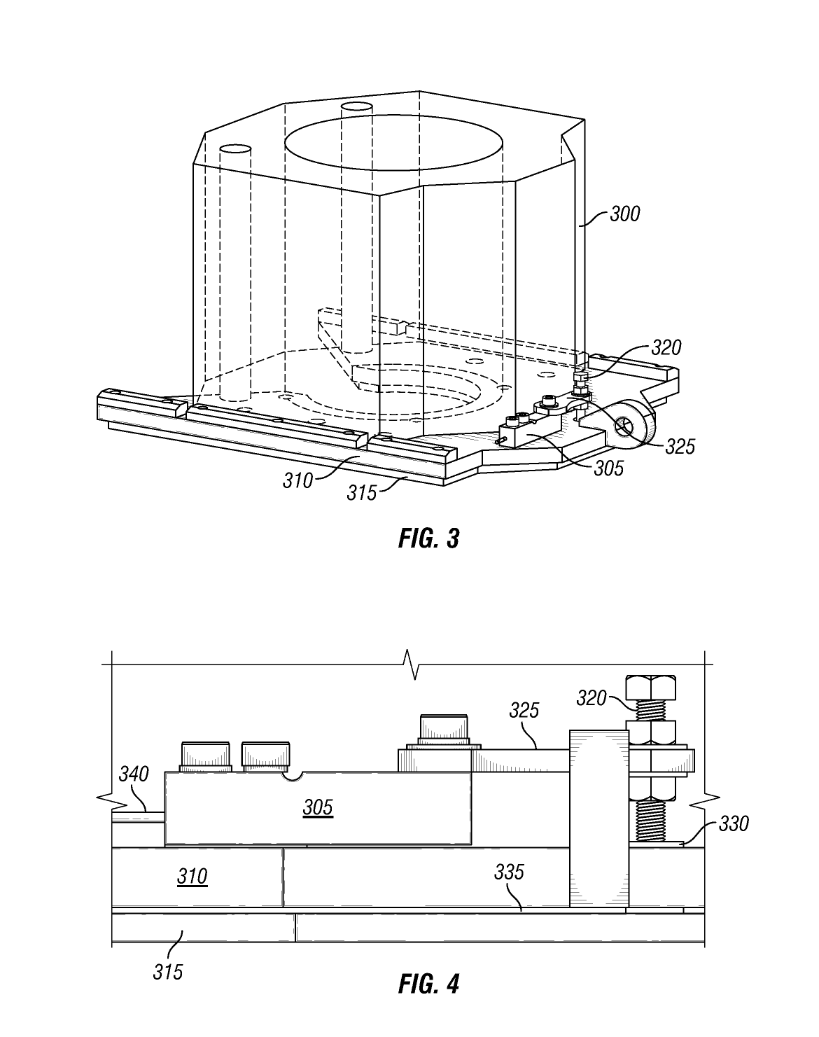

FIG. 3 is an illustrative implementation of a stationary heavy slip 300 with a weight sensor 305. Stationary heavy slip 300 may be utilized in pipe heavy conditions. Slip(s) 300 may be fitted with weight sensors 305 that determine if there is any weight in the slips. FIG. 4 is a close up view of an illustrative implementation of weight sensor 305. Weight sensor 305 may be installed in conjunction with slide plates 310, 315. A top plate 310 and bottom plate 315 are sandwiched together with weight sensor 305 secured to top plate 310. An adjusting screw 320 is mounted to weight sensor 305 via leaf spring 325. Adjusting screw 320 press against lower plate 315 through a plunger 330, such that at no load, a gap 335 between top and bottom plate 310, 315 is created. For example, gap 335 may be as small as 0.03 inches. However, any suitable gap may be utilized between top and bottom plate 310, 315.

When the slip 300 is closed and workstring weight is imposed on the slip, gap 335 is reduced and load sensor 305 detects an increase in load. For example in the arrangement shown, slip 300 is provided for pipe heavy conditions and an increase in load detected by weight sensor 305 indicates that the slip is controlling the weight of a workstring. In some implementations, the weight sensors may detect load up to an upper limit. For example, if a workstring weight exceeds about 500-1000 lb-ft, gap 335 may be fully closed and no further weight increase will be registered.

Signals from weight sensors 305 are provided to a controller via a signal cable 340 to register load, changes in load, and the like. The controller may utilize data from weight sensors 305 to determine if load is being held by a slip 300, detect changes in load, and the like. In some implementations, slip interlock system may also provide logging. Data regarding measured workstring weight by the sensors, triggered alarms, operation modes, and the like may be logged and stored.

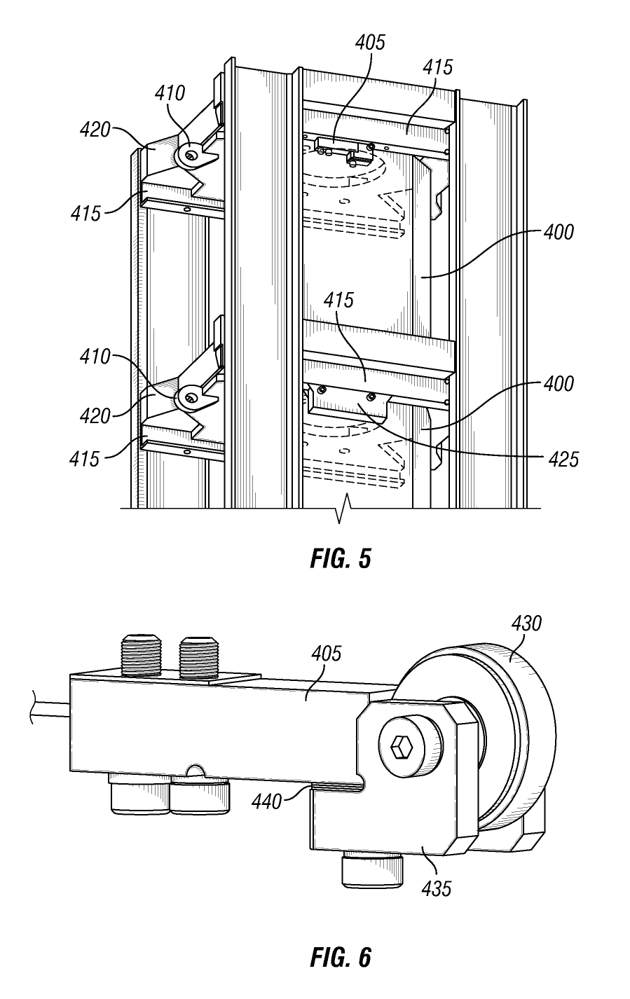

FIG. 5 is an illustrative implementation of a stationary snub slip 400 with weight sensors 405. Stationary snub slips 400 may be utilized for pipe light conditions. Slip(s) 400 are secured to slide plates 410. Slide plate 410 slides into guide angle bars 415 below snub plate 420. Weight sensors 405 are secured to the guide angle bars 415 for the slide plates 410. On the bottom, weight sensor 405 is shown with protective cover 425.

FIG. 6 is a close of view of an illustrative implementation of weight sensor 405. Weight sensor 405 interfaces with slide plate 410 through a cam 430. Cam 430 allows slide plate 410 and slip 400 to be easily inserted and removed from guide angle bars 415 with minimal obstruction from weight sensor 405. Adaptor 435 is secured to weight sensor 405 with one or more shims 440. The number of shims 440 is selected to lift slide plate 410 and slip 400 slightly off of guide angle bar 415 to a desired height. However, not so much that slip 400 touches the bottom of snub plate 420.

As a result, weight sensor 405 senses at least a portion of the weight of slip 400 when there is no load in slip 400 from a workstring. When a stationary snub slip 400 is closed and a weight transfer is made, the wellhead pressure exerts an upward force on the workstring and causes the workstring to lift stationary snub slip 400 off of weight sensor 405. If the wellhead pressure is sufficient, the workstring lifts stationary snub slip 400 until it rests up against snub plate 420. When the snub bowl hits snub plate 420, there is no load detected by weight sensor 405.

In contrast to weight sensor 305 of FIG. 4, when weight sensor 405 detects a reduction in load, it indicates that stationary snub slip 400 controls a workstring load. Conversely, when weight sensor 405 detects an increase in load, stationary snub slip 400 is not supporting a workstring load. For example, slip 400 is provided for pipe light conditions so a decrease in load detected by weight sensor 405 indicates that the wellhead pressure is attempting to eject the workstring so the slip is controlling the weight of a workstring.

User Interface

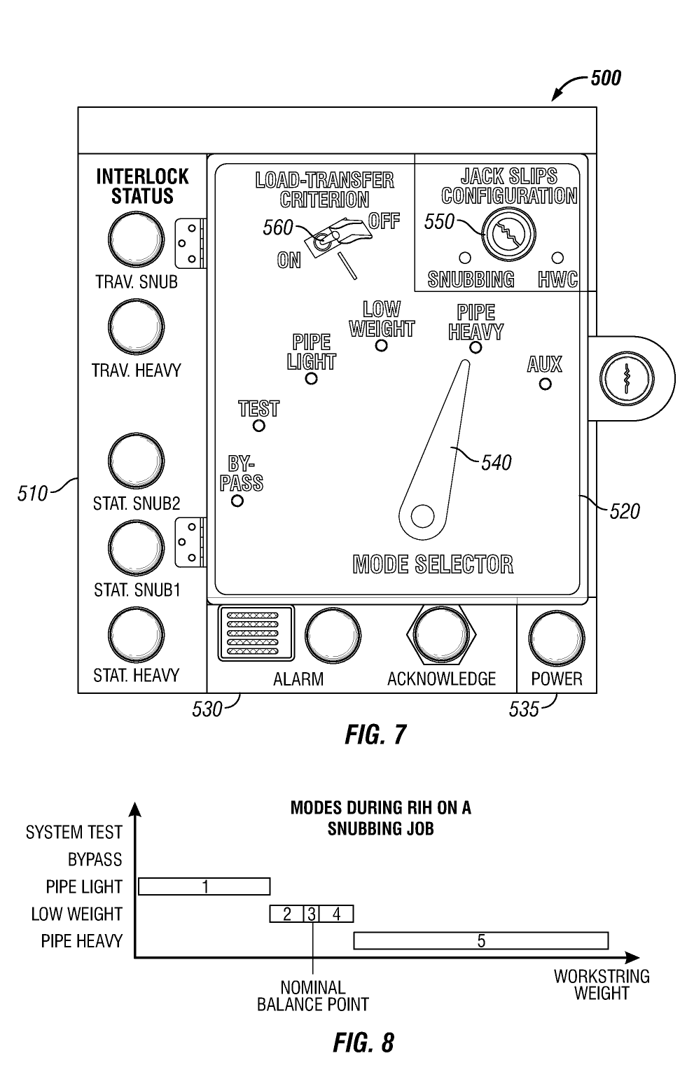

FIG. 7 is an illustrative implementation of a user interface 500 for a slip interlock system. User interface 500 may be divided into three main areas: status indicator area 510, operational mode area 520, and alarm handling area 530. Status indicator area 510 may provide multiple interlock status indicators that indicate which slip(s) is registering weight and which solenoids are energized to lock a slip from opening. Operational mode area 520 provides several mode selectors for selecting an operation mode. In some implementations, the operation mode area may be covered by a lockable cover. Alarm handling area 530 may provide audio and/or visual alarm(s), as well as an input for acknowledging that the alarm has been received. Further, user interface 500 may provide a power indicator 535 indicating that the slip interlock system is operational.

Status indicator area 510 may provide indicators for each slip of the snubbing unit. The indicators may provide information regarding an interlock status of each slip. For example, a light indicator may be illuminated to indicate that a slip is operational in a mode selected by the operator, and the indicator may be illuminated to a different color when the slip is loaded or controlling the weight of a workstring. Further, the light indicators may be illuminated to another color to indicate that an interlock is actively preventing a slip from being opened.

Operational mode area 520 may provide one or more dials that allow an operator to select a desired mode. A mode selector switch 540 may provide for selection of bypass, test, pipe light, low weight, pipe heavy, and aux modes. A slip configuration switch 550 may provide for selection between snubbing or HWO jack configurations. For example, if a snubbing unit is being used for a live well all slip the slips may be in use and a snubbing configuration should be selected. In a dead well, slips for pipe heavy conditions are utilized and a HWO configuration should be selected. In a HWO configuration, the slip interlock system may ignore data for snubbing slips. A load transfer switch 560 allows an operator to select between on and off modes. When a workstring is around a balance point, an operator may wish to force a load transfer from one slip to another slip using the other slip(s) in the snubbing unit. When load transfer switch 560 is in the on mode, the slip interlock system allows such operation without interference from the slip interlock system.

Alarm handling area 530 may provide one or more alarm indicators 570, which may be visual and/or audio indicators. The alarm indicators may indicate when an undesirable operation has occurred. For example, alarm indicator may provide alarms for attempts to open a slip that is locked by the interlock; erroneous slip handle position when changing the mode selector switch; power supply failure, and the like. Alarm indicators 570 may provide a unique audio and/or video indication for each different undesirable condition that has occurred. For example, a different audio tone, audio recording, and/or colored light for the different undesirable conditions that may be encountered. Further, alarm handling area may provide an acknowledge button 580. Acknowledge button 580 may be selected when an operator has acknowledged an undesirable state and wishes to shut off the audio alarm and/or visual alarm. In some implementations, a visual alarm may remain active after acknowledge button 580 is pressed while the audio alarm is shut off, and the visual alarm only shuts off after the undesired state is remedied.

The slip interlock system is designed to cover all modes of snubbing and hydraulic workover (HWO). FIG. 8 is an illustrative bar graph of various modes provided by the slip interlock system and the various phases of workstring weight that may be encountered in these modes. The modes provided in the graph correspond to the different modes that may be selected with the mode selector switch 540 on the user interface 500. Accordingly, an operator may set mode selector switch 540 to a particular mode corresponding to a workstring weight phase encountered. For example, the slip interlock system may be set to pipe light mode when phase 1 is encountered, to low weight mode when phases 2-4 are encountered, and to pipe heavy mode when phase 5 is encountered. System test mode is a mode utilized to test slip interlock system. Bypass mode may be utilized to bypass the slip interlock system, such as for setup of the snubbing unit in preparation snubbing, maintenance, or the like. In both the system test and bypass modes, the snubbing unit should not be in operation so the various phases of workstring weight are not encountered in these modes. An AUX mode may be utilized to provide a programmed mode for an operator. In the instance that an operator desires a specially programmed mode of operation for the slip interlock system, the AUX mode can be utilized to provide the special mode. For example, an operator may desire a mode in which the slip interlock system prevents actuation when string weight is equal to or greater than a predetermined weight (e.g. 20,000 lbs), which can be provided by the AUX mode.

When the snubbing unit is in operation, various phases of workstring weight may be encountered. The corresponding pipe light, low weight, and pipe heavy modes that are utilized for the different phases is discussed herein. Pipe light mode is used when there is no risk that an unexpected reduction in well pressure will unexpectedly turn the workstring heavy. Pipe light mode should be used when measured workstring forces indicate pipe light conditions. For example, when measured workstring force is less than a first predetermined amount, such as −5000 lb-ft, workstring weight may be considered to be in phase 1. It is not desirable to use stationary heavy slips in pipe light conditions so an alarm may be provided if stationary heavy slips are used. However, note that the use of stationary heavy slips is not prevented.

As more joints are added to the workstring the workstring weight approaches the balance point. Close to and around the balance point, smaller and smaller variations in well pressure may unexpectedly turn the string from light to heavy and vice versa. Phase 2 indicates workstring weight that is slightly pipe light, but close to the balance point. Phase 3 indicates that the workstring weight is at the balance point or very close to the balance point. Phase 4 indicates that the workstring weight is slightly pipe heavy, but close to the balance point. As small changes in well pressure can unexpectedly change conditions between pipe heavy and pipe light, the low weight mode is the most problematic. Stationary slips for pipe heavy and pipe light conditions should both be utilized in the low weight mode in case of an unexpected change in conditions. In the low weight mode the measured workstring force may be between a first predetermined amount and a second predetermined amount. For example, the low weight mode may be suitable for measured workstring forces between −5000 lb-ft to 5000 lb-ft.

When even more joints are added to the workstring, the weight of the workstring may exceed a second predetermined amount and considered to be in the pipe heavy mode. For example, measured workstring forces greater than 5000 lb-ft may be considered to be in phase 5 or pipe heavy mode. In pipe heavy mode, it is not desirable to use stationary snub slips so an alarm may be provided if stationary snub slips are used. However, note that the use of stationary snub slips is not prevented. Note that the first and second predetermined amounts provide above are provided for illustrative purposes only. The invention is in no way limited to the values discussed above as the desired values for the predetermined amounts may vary for different snubbing units, slips, or the like.

Secondary Interface

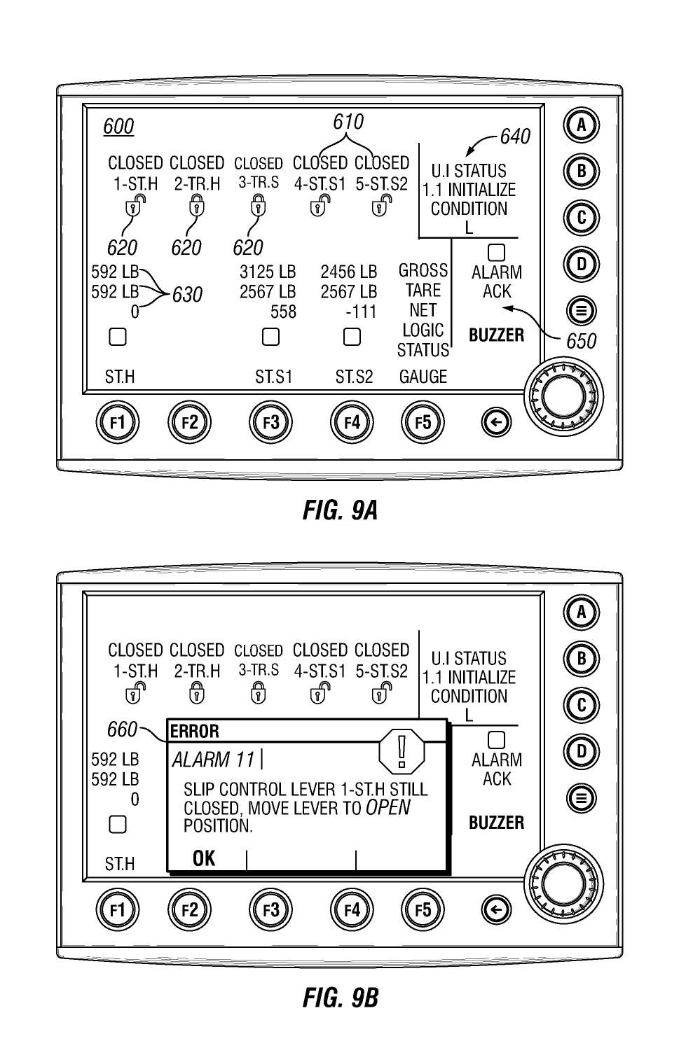

FIG. 9a is an illustrative implementation of a secondary interface 600. In some implementations, it may be desirable to provide a secondary interface 600. For example, a user interface may be provided in an area proximate to a work basket, such as with the location of controller 40 in FIG. 1. In order to make information provided by the slip interlock system more accessible at different locations, it may be desirable to provide a secondary interface 600 at another location. Secondary interface 600 may provide a slip status indicators 610 indicating whether the slip valve handle is opened or closed. Interlock status indicators 620 may indicate whether an interlock has been locked. For example, a padlock icon may be green to indicate that the interlock is unlocked and red to indicate that the interlock is locked. Weight indicators 630 may indicate a measured weight detected by the slip interlock system. Secondary interface 600 may also provide information on user interface settings 640 and alarm status 650. Secondary interface 600 may also provide popup window(s) 660 when an alarm occurs as shown in FIG. 9b. Popup window 660 may provide information indicating what triggered the alarm and an explanation on how to remedy the issue.

Implementations described herein are included to demonstrate particular aspects of the present disclosure. It should be appreciated by those of skill in the art that the implementations described herein merely represent exemplary implementation of the disclosure. Those of ordinary skill in the art should, in light of the present disclosure, appreciate that many changes can be made in the specific implementations described and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The implementations described hereinabove are meant to be illustrative only and should not be taken as limiting of the scope of the disclosure.

What is claimed is:

1. A slip interlock system comprising:
a slip for a snubbing unit, wherein the slip is operable between an open position and a closed position;
a valve controlling the slip, wherein the valve actuates the slip between the open and closed positions;
a weight sensor coupled to the slip, wherein the weight sensor measures a load on the slip to determine whether the slip controls the weight of a workstring; and
an interlock coupled to the valve, wherein the interlock prevents the valve from actuating from the closed position into the open position when the slip controls the weight of the workstring.

2. The system of claim 1, wherein the weight sensor is configured to measure the load in pipe heavy conditions.

3. The system of claim 1, further comprising:
a top slide plate for the slip coupled to the weight sensor;
a bottom slide plate for the slip, wherein the bottom slide plate is separated from the top slide plate by a predetermined gap; and
a leaf spring attached to the weigh sensor, wherein a fastener attaches the leaf spring to the bottom slide plate, and an increase in the load measured by the weight sensor indicates that the slip controls the weight of the workstring.

4. The system of claim 1, wherein the weight sensor is configured to measure the load in pipe light conditions.

5. The system of claim 1, further comprising:
a slide plate for the first slip;
guides provided on the snubbing unit for receiving the slide plate, wherein the weight sensor is secured to one of said guides; and
an adapter with a cam coupled to the weight sensor, wherein the cam receives the load from the slide plate and the slip, and a decrease in the load measured by the weight sensor indicates that the slip controls the weight of the workstring.

6. The system of claim 1, wherein the interlock comprises a solenoid with a stem, and the stem of the solenoid extends to prevent the first valve from actuating from the closed position into the open position when the solenoid is energized.

7. The system of claim 6, wherein the stem of the solenoid retracts when the solenoid is de-energized.

8. The system of claim 1, further comprising:
a proximity sensor coupled to the valve, wherein the proximity sensor detects a position of the valve; and
an alarm for notifying an operator, wherein the alarm is activated when the operator attempts to actuate the valve from the closed position into the open position while the slip controls the weight of the workstring.

9. The system of claim 1, further comprising a user interface, the user interface displaying a status of the interlock.

10. A slip interlock system comprising:
a snubbing unit for snubbing operations, the snubbing unit comprising
a first stationary slip for pipe heavy conditions, and
a second stationary slip for pipe light conditions, wherein the first and second stationary slips are operable between an open position and a closed position;
a weight sensor coupled to each of the first and the second stationary slips, wherein a first weight sensor measures a load on the first stationary slip, and a second weight sensor measures a load on the second stationary slip;
a valve bank coupled to the first and second stationary slips, wherein a first valve provided by the valve bank actuates the first stationary slip between the open and closed positions, and a second valve provided by the valve bank actuates the second stationary slip between the open and closed positions;
a first interlock coupled to the first valve, wherein the first interlock prevents the first valve from actuating from the closed position to the open position when the first stationary slip controls the weight of the workstring; and
a second interlock coupled to the second valve, wherein the second interlock prevents the second valve from actuating from the closed position to the open position when the second stationary slip controls the weight of the workstring.

11. The system of claim 10, further comprising:
a top slide plate for the first stationary slip coupled to the first weight sensor;
a bottom slide plate for the first stationary slip, wherein the bottom slide plate is separated from the top slide plate by a predetermined gap; and
a leaf spring attached to the first weigh sensor, wherein a fastener attaches the leaf spring to the bottom slide plate.

12. The system of claim 10, further comprising:
a slide plate for the second stationary slip;
guides provided on the snubbing unit for receiving the slide plate, wherein the second weight sensor is secured to one of said guides; and
an adapter with a cam coupled to the second weight sensor, wherein the cam receives the load from the slide plate.

13. The system of claim 10, wherein the first and second interlocks each comprise a solenoid with a stem, and the stem of the solenoid extends to prevent the first valve or the second valve from actuating from the closed position into the open position when the solenoid is energized.

14. The system of claim 13, wherein the stem of the solenoid retracts when the solenoid is de-energized.

15. The system of claim 10, further comprising:
a proximity sensor coupled to each of the first valve and the second valve, wherein the proximity sensors detects a position of the valve; and
an alarm for notifying an operator, wherein the alarm is activated when the operator attempts to actuate the first valve from the closed position into the open position while the first stationary slip controls the weight of the workstring, and the alarm is activated when the operator attempts to actuate the second valve from the closed position into the open position while the second stationary slip controls the weight of the workstring.

16. The system of claim 10, further comprising a user interface, the user interface displaying a status of the first and second interlocks.

17. The system of claim 10, further comprising a mode selector, wherein the mode selector provides a pipe light mode for pipe light conditions, low weight mode for conditions near a balance point, and a pipe heavy mode for pipe heavy conditions.

18. A method controlling slip interlock system for a snubbing unit, the method comprising:
coupling a weight sensor to a slip of a snubbing unit, wherein the weight sensor measures a load on the slip;
coupling an interlock to a valve controlling actuation of the slip between an open position and a closed position, wherein the interlock prevents the valve from opening when the interlock is actuated to a first position;
determining whether the slip controls the weight of a workstring in accordance with the measured load; and
actuating an interlock to the first position when the load measured indicates that the slip controls the weight of the workstring.

19. The method of claim 18, wherein the weight sensor is configured to measure the load in pipe heavy conditions.

20. The method of claim 18, wherein the weight sensor is configured to measure the load in pipe light conditions.

21. The method of claim 18, wherein an increase in the load measured indicates that the slip controls the weight of the workstring.

22. The method of claim 18, wherein a decrease in the load measured indicates that the slip controls the weight of the workstring.

23. The method of claim 18, further comprising:
coupling a proximity sensor to the valve, wherein the proximity sensor detects movement of the valve between the open position and the closed position; and
providing an alarm when an operator attempts to actuate the valve from the closed position into the open position while the slip controls the weight of the workstring.

24. The method of claim 18, further comprising a user interface, the user interface displaying a status of the interlock.

25. The method of claim 18, further comprising a mode selector, wherein the mode selector provides a pipe light mode for pipe light conditions, low weight mode for conditions near a balance point, and a pipe heavy mode for pipe heavy conditions.
